(19) United States
(12) Patent Application Publication
(10) Pub. No.: US 2005/0212348 A1
(43) Pub. Date: Sep. 29, 2005

(54) Rim cover structure with glittering lights

(76) Inventor: Chiang Lung Cheng, Yung Kang City (TW)

Correspondence Address: Leong C Lei, PMB #1008 1867 Ygnacio Valley road, Walnut Creek, CA, 94598, US

(21) Appl. No.: 10/806,230

(22) Filed: Mar. 23, 2004

(51) Int. Cl. B60B 7/10

(52) U.S. Cl. 301/37.108

(57) ABSTRACT

The present invention concerns a rim cover structure with glittering lights which provides glittering lights on the rim cover during the spinning, adding safety and prettiness. It mainly has light-emitting components installed on the adorning surface of the rim cover, inside the installed concaves or behind the penetrating openings, so that when the tire is in motion and vibrates, it will activate the Light Emitting Diode of the light-emitting component, in turn becoming a product with true effectiveness and promote the utility value of the said product.

### BACKGROUND OF THE INVENTION

(a) Technical Field of the Invention

The present invention concerns a rim cover structure with glittering lights, and in particular one with light emitting components installed on the adorning surface that shine and glitter when the tire rim is spinning.

(b) Description of the Prior Art

FIG. 1, FIG. 2 and FIG. 3 refer respectively to the perspective view of the prior art, and the perspective view and exploded view of another prior art. Wherein, the body (1) structure in FIG. 1 has a rim cover (30) installed on the tire (2) rim (20). Whereas, the body (1) structure in FIG. 2 and FIG. 3 has a rim (30) cover installed on the tire (2) rim (20), with a penetrating opening (301) installed in the middle of the rim cover (30), a wheel axle cover with logo on top is screw fixed on the penetrating opening (301) to make the appearance of the rim (20) neat. Because the prior arts are dull without any adornments, totally unappealing, not pretty and do not glitter during advancement; not only are they unable to satisfy the desire for novelty and variety of modern car people, the bad structure design itself provides no help towards increasing safety during advancement day or night. The above-mentioned defects have been the denouncements and persecutions of manufacturers and consumers for a long time. Therefore, it is necessary to provide a rim cover structure with glittering lights, which will increase effectiveness and promote the utility value of said product. This is also the main object of the present invention.

### SUMMARY OF THE INVENTION

A main object of the present invention is to improve the dullness, stiffness and ugliness of the rim cover, make it glitter and be safer. The present invention seeks to make the rim cover glitter during spinning, to adorn the rim cover, make it more appealing, and prettier. Glittering lights will be emitted during advancement to satisfy the desire for novelty and variety of modern car people and even more increase the safety of advancement during day or night. Therefore, the main purpose of the present invention is to provide a rim cover structure with glittering lights, which will glitter when the rim cover spins, improving safety and provide a pretty appearance.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of a prior art invention;

FIG. 2 is a perspective view of another prior art invention;

FIG. 3 is an exploded view of FIG. 2;

FIG. 4 is an exploded view of the present invention;

FIG. 5 is a perspective view of the assembled present invention;

FIG. 6 is an exploded view of the present invention in motion;

FIG. 7 is another preferred embodiment of the present invention;

FIG. 8 is still another preferred embodiment of the present invention.

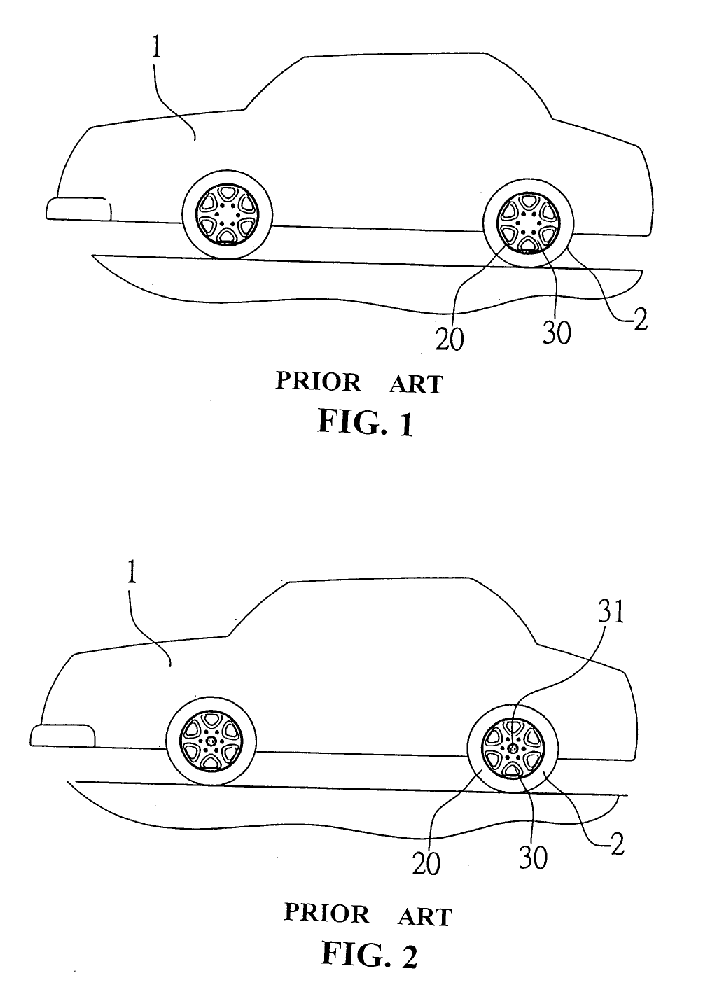

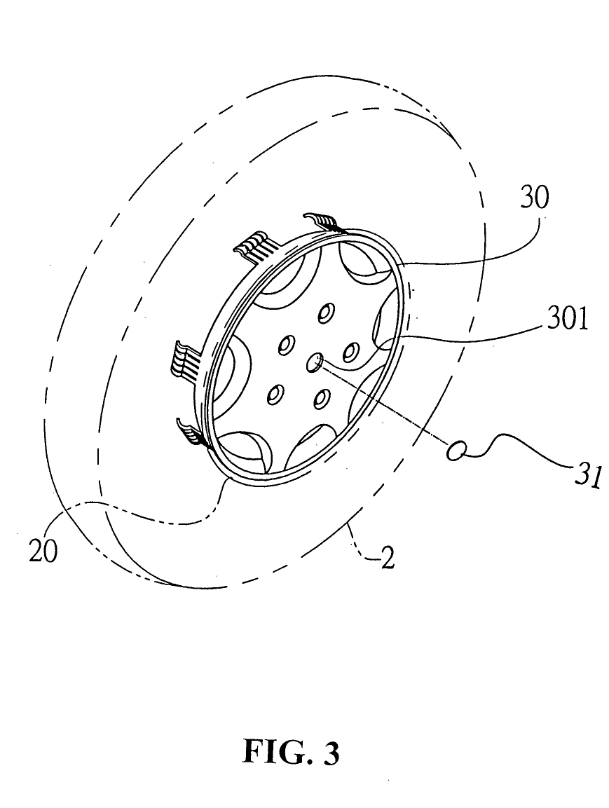

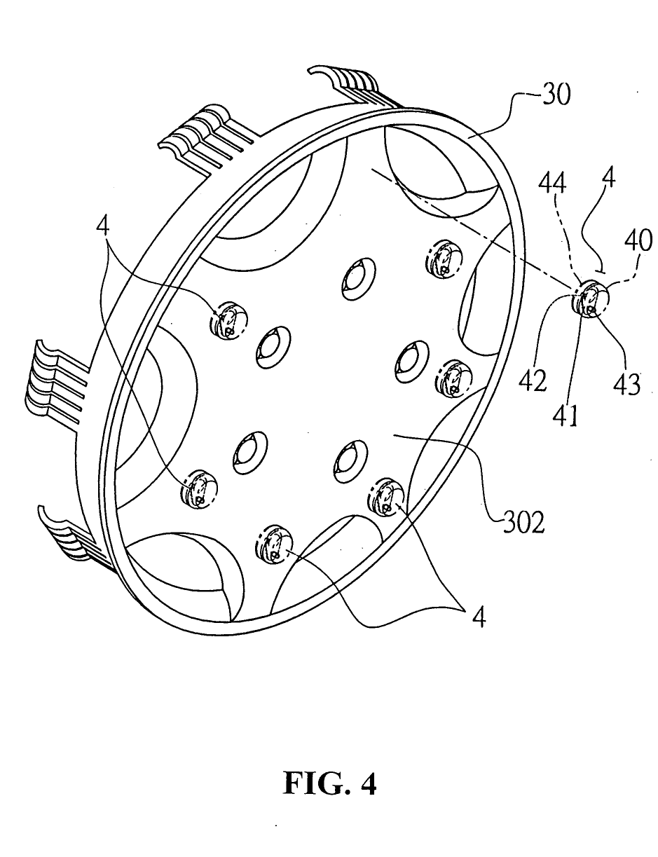

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

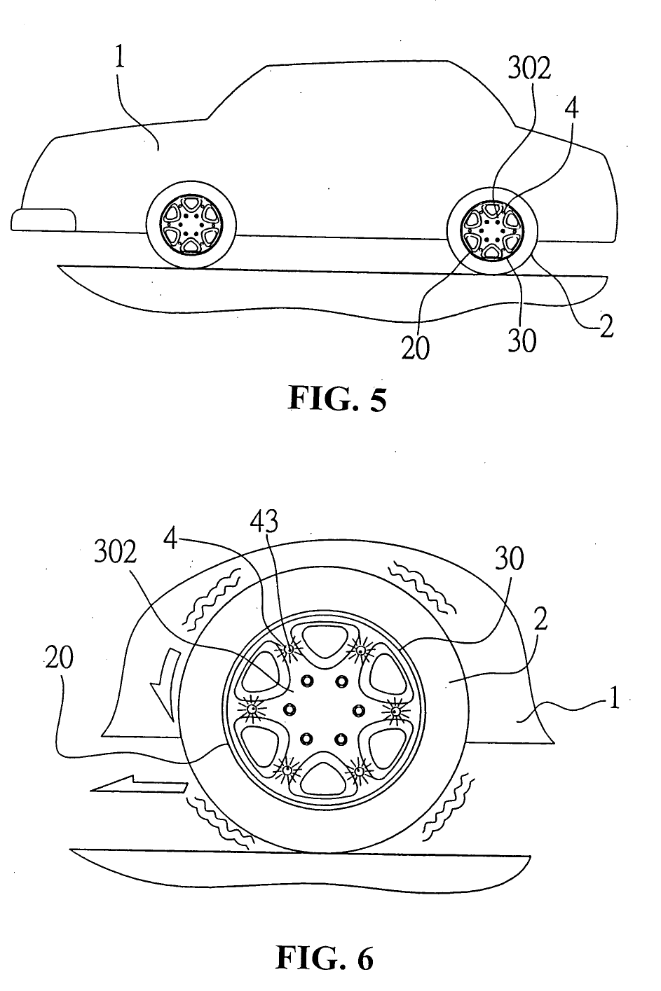

Referring to FIG. 4 and FIG. 5 for the exploded view of the present invention and the perspective view of the assembled present invention, mainly establishing light-emitting component (4) mantle pieces on the top, bottom, right and left of the rim cover (30). Because the said light-emitting component (4) has a sealed compartment (40) installed on the outside, and a battery (42) to provide power, circuit board (41) for control and glittering light (43) (Light Emitting Diode) to provide the glittering light source installed in the inside. In order for the said light-emitting component (4) to be attached to the adorning surface (302) of the rim cover (30) conveniently and quickly, a strong pasting part (44) is installed underneath. The assembling is simply achieved by sticking on the light-emitting component. Since the circuit board (41) has the vibration switch function, when the tire (2) spins, the rim cover (30) of the tire (2) and the light-emitting component (4) on the adorning surface (302) will spin along as well. Therefore, when the circuit board (41) feels the vibration, it will control the activation and shut down of the glittering light (43) (Light Emitting Diode). Moreover, the light-emitting component (4) reveals the full water proof function by utilizing the sealed compartment (40). As for the number of light-emitting component (4) allowed, it may go from at least one to as many as it can allow depending on the size of the adorning surface (302).

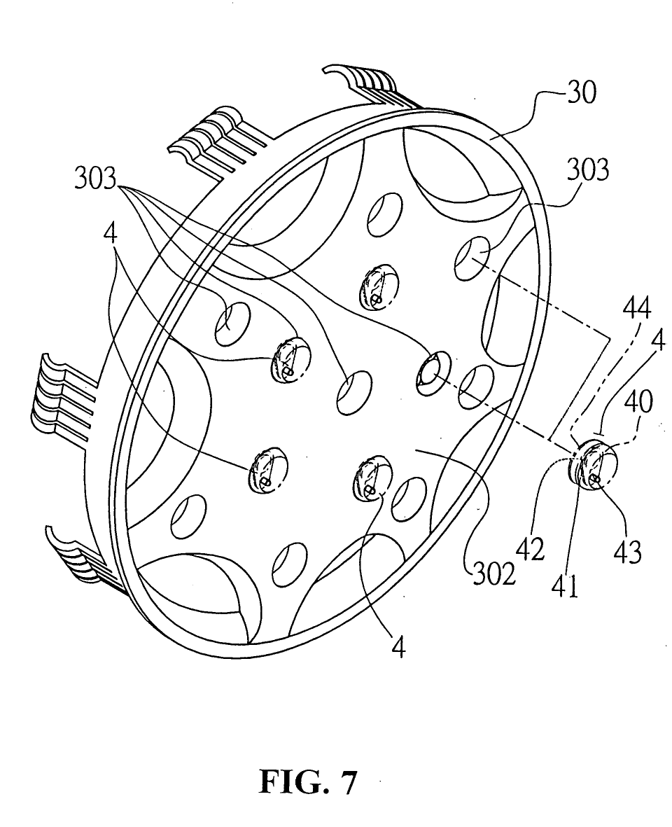

Referring to FIG. 6, when the rim cover (3) installed on the rim (20) of the body (1) spins along with the spinning of the tire (2), due to the light-emitting component (4) installed on the adorning surface (302), the light-emitting component (4) will feel the vibration by spinning along, and the glittering light (43) (Light Emitting Diode) will be activated and glitter. Consequently, the appearance is showy and unique; it attracts attention and is more eye-catching at nighttime. The glittering light enables the driver to see the rim cover (30) glitter; it is safer and changes the simple and dullness of the prior arts. The present invention light-emitting component (4) will only glitter when in advancement (tire (2) in motion); accordingly, the glittering light (43) (Light Emitting Diode) does not act in still motion, when the body (1) advances, the tires (2) spin and glitter.

Referring to FIG. 7, the adorning surface (302) on the rim cover (30) has concaves (303) additionally installed for fixing, and the concaves (303) provide a fixing space for the light-emitting component (4) with pasting part (44) on the back. Likewise, the light-emitting component (4) includes a water proof sealed compartment, and within it is the battery (42) for providing power, the circuit board (41) to control the vibration switch, and the glittering light (43) (Light Emitting Diode) to provide glittering lights.

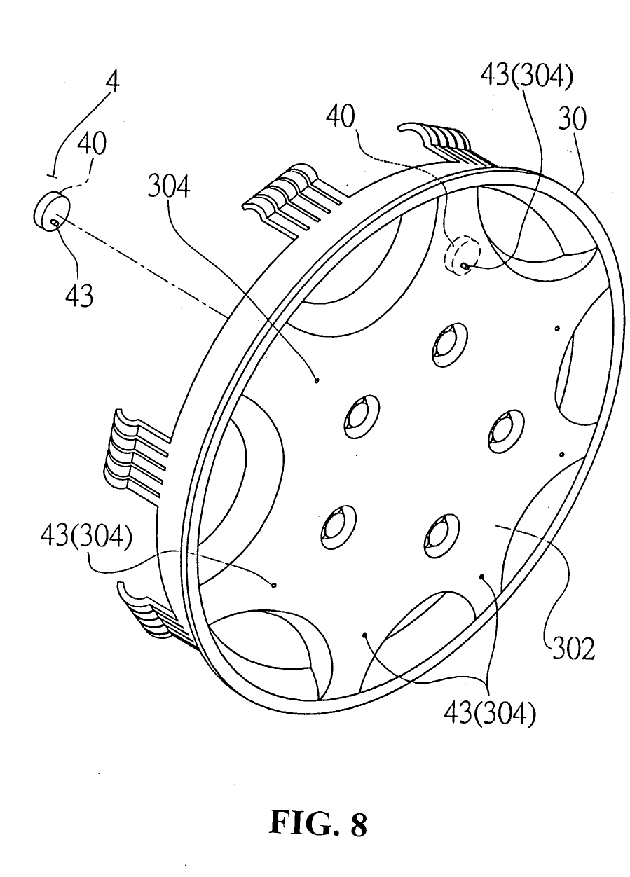

Referring to FIG. 8, penetrating openings (304) are installed on the rim cover (30), and the light-emitting components (4) are installed at the back of the penetrating openings (304). Because the light-emitting components (4) has the glittering light (43) (Light Emitting Diode) installed on top of the sealed compartment (40), the glittering light (43) (Light Emitting Diode) protrudes through the penetrating openings (304) and outside the adorning surface (302). Therefore, the present invention does not require manual operation, it is easy to fix, has good visual effect, high security, glitters at night and gives drivers a better vision.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

1. A rim cover structure with glittering lights providing the rim cover to glitter during spinning and add safety, wherein the light-emitting component has a battery for providing power, a circuit board to control the glittering and glittering light (Light Emitting Diode) to provide glittering lights installed within the transparent sealed compartment; the main characteristic is that there is at least one light-emitting component installed on the adorning surface of the rim cover, and the glittering light (Light Emitting Diode) will be activated by the vibration caused from the advancement.

2. The rim cover structure with glittering light as claimed in claim 1, wherein the adorning surface of the rim cover has at least one concave installed for the fixing of the light-emitting component.

3. The rim cover structure with glittering light as claimed in claim 1, wherein the adorning surface of the rim cover has at least one penetrating opening installed, providing the light-emitting component to be installed at the back, and the glittering light of the light-emitting component to protrude on the adorning surface and through the penetrating opening.

4. The rim cover structure with glittering light as claimed in claim 1, wherein the light-emitting component with the glittering light may amount to twenty at the most.
